(19) United States
(12) Patent Application Publication
(10) Pub. No.: US 2012/0213281 A1
(43) Pub. Date: Aug. 23, 2012

(54) METHOD AND APPARATUS FOR ENCODING AND DECODING MULTI VIEW VIDEO

(75) Inventors: Woong-il CHOI, Osan-si (KR); Byeong-doo CHOI, Siheung-si (KR)

(73) Assignee: SAMSUNG ELECTRONICS CO., LTD., Suwon-si (KR)

(21) Appl. No.: 13/400,976

(22) Filed: Feb. 21, 2012

(30) Foreign Application Priority Data
Feb. 21, 2011 (KR) 10-2011-0015034

(51) Int. Cl. H04N 7/32

(52) U.S. Cl. 375/240.16; 375/E07.123

(57) ABSTRACT

A method and apparatus for encoding and decoding video for brightness value compensation of multi-view video by using an offset value, which is a difference between an average value of pixels of the current block and an average value of pixels of the reference block, to the prediction block to compensate for an illumination value of the prediction block

### CROSS-REFERENCE TO RELATED PATENT APPLICATION

This application claims priority from Korean Patent Application No. 10-2011-0015034, filed on Feb. 21, 2011, in the Korean Intellectual Property Office, the disclosure of which is incorporated herein by reference in its entirety.

### BACKGROUND

1. Field

Exemplary embodiments relate to methods and apparatuses for video encoding and decoding, and more particularly, to a method and apparatus for encoding and decoding video for brightness correction of a stereo image and multi-view video.

2. Description of the Related Art

In multi-view coding (MVC) for three-dimensional (3D) display applications, when predicting between adjacent views, an illumination change between the adjacent views is generated due to an incompletely calibrated camera, a different perspective projection direction, and different reflection effects, thereby decreasing encoding efficiency. Also, in a single view, encoding efficiency may decrease according to a brightness change due to a scene change.

### SUMMARY

The exemplary embodiments provide a method and apparatus for encoding and decoding video for brightness correction of a stereo image or multi-view image.

According to an aspect of an exemplary embodiment, there is provided a method of encoding video, the method comprising: determining a motion vector and a reference block of an encoded current block by performing motion prediction on the current block; determining an offset value of the current block that is a difference between an average value of pixels of the current block and an average value of pixels of the reference block; generating an offset prediction value of the current block by using at least one of a motion vector predictor of the current block and peripheral blocks of the current block restored after being encoded; and encoding a difference value that is a difference between the offset value of the current block and the offset prediction value of the current block.

According to another aspect of an exemplary embodiment, there is provided a method of decoding video, the method comprising: decoding offset information and information about a motion vector of a current block decoded from a bit stream; generating an offset value of the current block based on the decoded offset information of the decoded current block; performing motion compensation on the current block based on the motion vector information of the decoded current block; and restoring the current block by adding a motion compensation value of the current block to the offset value of the current block, wherein the offset information comprises a difference value that is a difference between an offset prediction value of the current block and the offset value of the current block, the offset prediction value of the current block generated by using at least one of a motion vector predictor of the current block and previously restored peripheral blocks of the current block.

According to another aspect of an exemplary embodiment, there is provided an apparatus for encoding video, the apparatus comprising: a prediction unit that determines a motion vector and a reference block of an encoded current block by performing motion vector predictor on the current block; an offset compensating unit that determines an offset value of the current block that is a difference between an average value of pixels of the current block and an average value of pixels of the reference block, generates an offset prediction value of the current block by using at least one of a motion vector predictor of the current block and peripheral blocks of the current block restored after being encoded, and compensating for a brightness value of a reference block of the current block by adding a motion compensation value of the current block and the offset; and an offset encoding unit that encodes a difference value that is a difference between the offset value of the current block and the offset prediction value of the current block.

According to another aspect of an exemplary embodiment, there is provided an apparatus for decoding video, the apparatus comprising: an offset decoding unit that decodes offset information of a current block decoded from a bit stream and generates an offset value of the current block based on the decoded offset information; a motion compensating unit that performs motion compensation on the current block based on motion vector information of the decoded current block; and an offset compensating unit that compensates for a brightness value of a reference block of the current block by adding a motion compensation value of the current block to the offset value of the current block, wherein the offset information comprises a difference value that is a difference between an offset prediction value of the current block and the offset value of the current block, the offset prediction value of the current block generated by using at least one of a motion vector predictor of the current block and previously restored peripheral blocks of the current block.

### BRIEF DESCRIPTION OF THE DRAWINGS

The above and other aspects will become more apparent by describing in detail exemplary embodiments thereof with reference to the attached drawings in which:

FIG. 1 illustrates a multi-view video sequence encoded according to a an exemplary embodiment of the present invention;

FIG. 2 is a block diagram of an apparatus for encoding video according to an exemplary embodiment;

FIG. 3 is a reference diagram for explaining offset prediction according to an exemplary embodiment;

FIGS. 4A through 4B illustrate blocks having various sizes that are adjacent to a current block according to an exemplary embodiment;

FIGS. 5A through 5C are diagrams for explaining a motion vector predictor used to determine an offset prediction value of a current block according to another exemplary embodiment;

FIG. 6 is a reference diagram for explaining determining of an offset prediction value of a current block by using a motion vector predictor according to another exemplary embodiment;

FIG. 7 is a flowchart illustrating a method of encoding video according to an exemplary embodiment;

FIG. 8 is a block diagram of an apparatus for decoding video according to an exemplary embodiment; and

FIG. 9 is a flowchart illustrating a method of decoding video according to an exemplary embodiment.

### DETAILED DESCRIPTION OF THE EXEMPLARY EMBODIMENTS

Hereinafter, one or more exemplary embodiments will be described in detail with reference to the accompanying drawings.

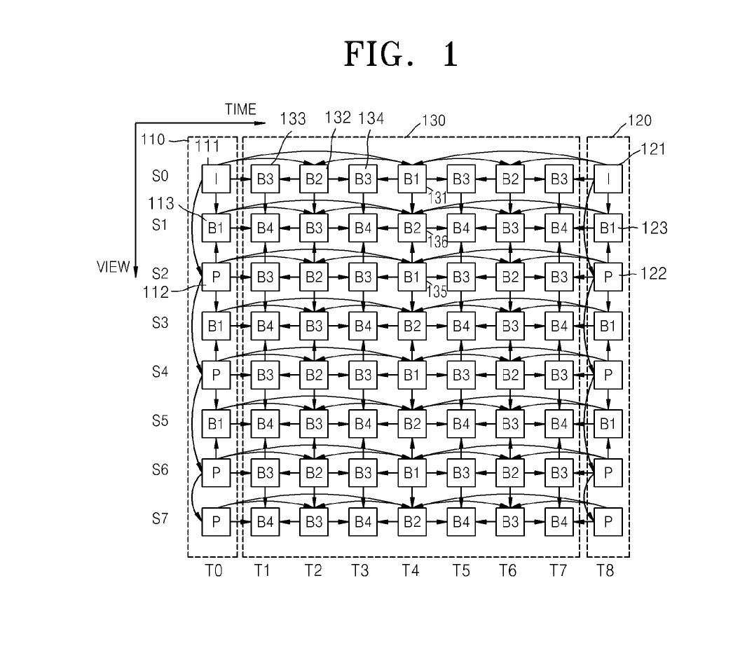

FIG. 1 illustrates a multi-view video sequence encoded according to an exemplary embodiment.

In multi-view video encoding, multi-view images input from a plurality of cameras are compression encoded by using temporal correlation and spatial correlation between cameras (inter-view).

In temporal prediction using the temporal correlation and inter-view prediction using the spatial correlation, motion of a current picture is predicted and compensated in a block unit by using at least one reference picture, and the images are encoded. That is, in multi-view image encoding, pictures input at different times from among pictures obtained from a different view camera or pictures having the same view are determined as reference pictures, a block that is most similar to a current block is searched for in a determined search range of the reference pictures, when the similar block is searched for, difference data between the current block and the similar block is transmitted, and the compression rate of data increases.

Referring to FIG. 1, an x-axis is a time axis and a y-axis is a view-point axis. T0 through T8 in the x-axis each indicate a sampling time of an image and S0 through S7 in the y-axis indicate each different view point. In FIG. 1, each row indicates an image picture group input at the same view point and each column indicates multi-view images at a same time.

In multi-view image encoding, intra pictures are periodically generated with respect to an image at a basic view point, and temporal prediction or inter-view prediction is performed based on the generated intra pictures, thereby prediction encoding other pictures.

The temporal prediction is prediction using temporal correlation between images at the same view, that is, images at the same row in FIG. 1. For temporal prediction, a prediction structure using hierarchical B pictures may be used. The inter-view prediction is prediction using temporal correlation between images at the same time, that is, images in the same column.

In the prediction structure of multi-view image pictures using hierarchical B pictures, when prediction using temporal correlation existing between the images at the same view, that is, images in the same row, is performed, the image picture groups at the same view are prediction encoded to Bi-directional pictures (hereinafter, referred to as “B pictures”) by using anchor pictures. Here, the anchor pictures denote pictures included in columns 110 and 120 of a first time T0 and a final time T8 including intra pictures from among the columns of FIG. 1. The anchor pictures 110 and 120 are prediction encoded by only using inter-view prediction except for the intra pictures (hereinafter, referred to as “I pictures”). Pictures included in remaining columns 130 except for the columns 110 and 120 including the intra pictures are referred to as non-anchor pictures.

For example, the image pictures input during a predetermined time period at the first view S0 are encoded by using the hierarchical B pictures as follows. A picture 111 input at the first time T0 and a picture 121 input at the final time T8 from among the image pictures input at the first view S0 are encoded to the I pictures. Then, a picture 131 input at T4 is bi-directional prediction encoded with reference to the I pictures 111 and 121, which are the anchor pictures, and thus is encoded to the B pictures. A picture 132 input at T2 is bi-directional prediction encoded by using the I picture 111 and the B picture 131 and thus is encoded to the B picture. Similarly, a picture 133 input at T1 is bi-directional prediction encoded by using the I picture 111 and the B picture 132 and a picture 134 input at T3 is bi-directional prediction encoded by using the B picture 132 and the B picture 131. As such, image sequences at the same view are bi-directional prediction encoded hierarchically by using the anchor pictures and thus such a prediction encoding method is called a hierarchical B picture. In Bn (n=1, 2, 3, 4) illustrated in FIG. 1, n indicates an n^{th}B picture that is bi-directional predicted. For example, B1 indicates a picture that is firstly bi-directional predicted by using the anchor pictures, which is an I picture or a P picture, B2 indicates a picture that is bi-directional predicted after the B1 picture, B3 indicates a picture that is bi-directional predicted after the B2 picture, and B4 indicates a picture that is bi-directional predicted after the B3 picture.

In multi-view video sequence encoding, image picture groups at the first view S0, which is the basic view, are encoded by using the hierarchical B pictures. In order to encode image sequences at remaining views, image pictures at even number views S2, S4, and S6 included in the anchor pictures 110 and 120 and at the final view S7 are prediction encoded to the P pictures through inter-view prediction using the I pictures 111 and 121 at the first view S0. Image pictures at odd number views S1, S3, and S5 included in the anchor pictures 110 and 120 are bi-directional predicted using image pictures at adjacent views through inter-view prediction and thus are predicted to the B pictures. For example, the B picture 113 input at the second view S1 at T0 is bi-directional predicted by using the I picture 111 and a P picture 112 at the adjacent views S0 and S2.

When the image pictures at all views included in the anchor pictures 110 and 120 are encoded to any one picture from among I, B, and P pictures, the non-anchor pictures 130 are bi-directional prediction encoded through temporal prediction and inter-view prediction using the hierarchical B pictures.

The image pictures at the even number views S2, S4, and S6 from among the non-anchor pictures 130 and at the final view S7 are bi-directional prediction encoded using the anchor pictures at the same view through temporal prediction using the hierarchical B picture. The pictures at the odd number views S1, S3, S5, and S7 from among the non-anchor pictures 130 are bi-directional prediction encoded through not only temporal prediction using the hierarchical B but also inter-view prediction using pictures at the adjacent views. For example, a picture 136 input at the second view S1 at T4 are predicted by using anchor pictures 113 and 123 and the pictures 131 and 135 at the adjacent views.

The P pictures included in the anchor pictures 110 and 120 are prediction encoded by using the I pictures at the different views input at the same time or previous P pictures. For example, a P picture 122 input at the third view S2 at T8 is prediction encoded by using an I picture 121 input at the first view S0 at the same time as a reference picture.

Hereinafter, it is assumed that an encoded current block is a block of video at a view encoded using a reference block of video at any one different view restored after being previously encoded in the multi-view video sequence illustrated in FIG. 1. For example, a reference block in 3D video formed of video of two views, such as a left image and a right image, is one of video from among left video and right video that are restored after being previously encoded and the encoded current block may be a video block at a view from the view of the reference block.

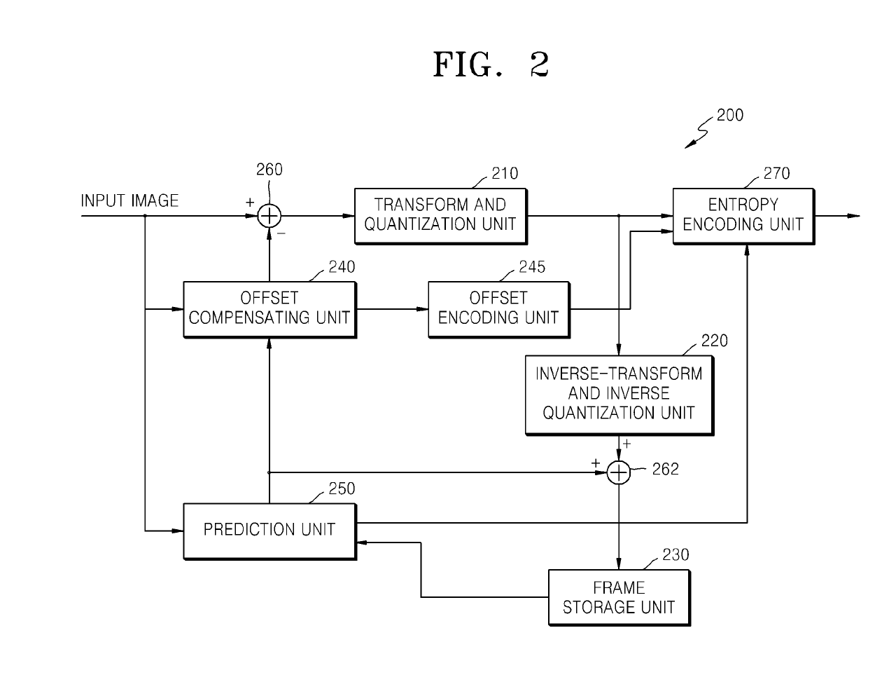

FIG. 2 is a block diagram of an apparatus 200 for encoding video according to an exemplary embodiment.

As described above, in image sequences input through cameras at different views, an illumination change between images at the same position at each different view is generated due to an incorrectly calibrated camera, a different perspective projection direction, or different reflection effects. In order to compensate for such an illumination difference, an apparatus for encoding video according to an exemplary embodiment adds an offset, which is a difference in an average value between the encoded current block and a prediction block of the current block, to the prediction block and thus compensates for an illumination value of the prediction block. In particular, the apparatus for encoding video according to an exemplary embodiment generates an offset prediction value by using an offset of peripheral blocks and a motion vector predictor of the current block when calculating an offset for illumination value correction, and thus reduces a bit rate required to encode offset information.

Referring to FIG. 2, the apparatus 200 for encoding video includes a transform and quantization unit 210, an inverse-transform and inverse quantization unit 220, a frame storage unit 230, an offset compensating unit 240, an offset encoding unit 245, a prediction unit 250, a subtraction unit 260, an addition unit 262, and an entropy encoding unit 270.

The prediction unit 250 generates a prediction block of an encoded current block and determines a motion vector of the current block and a reference block when predicting motion. Also, the prediction unit 250 outputs the motion compensated reference block generated as a result of the motion prediction to the offset compensating unit 240. In the present exemplary embodiment, a block corresponding to the reference picture, which is a motion prediction value of the current block, is referred to as the reference block or a motion compensation value. As described above, in single view video encoding, the reference block may be a block in a previous restored frame or a block in a frame of a different color component that is previously restored in the current frame. In multi-view video encoding, the reference block may be a block in a frame at any one view restored after being firstly encoded from among video sequences at a plurality of views.

In order to remove spatial redundancy of image data, the transform and quantization unit 210 transforms residual data, which is a difference between a prediction block, which is predicted in the prediction unit 250 and an illumination value thereof is corrected by the offset compensating unit 240, and the current block to a frequency region. Also, the transform and quantization unit 210 quantizes transform coefficient values obtained as a result of frequency transform according to a predetermined quantization step. An example of a scene change may include discrete cosine transform (DCT).

The inverse-transform and inverse quantization unit 220 inverse-quantizes image data quantized in the transform and quantization unit 210 and inverse-transforms the inverse-quantized image data.

The addition unit 262 adds a prediction image of the current block, in which an illumination value output from the prediction unit 250 is compensated, to data restored in the inverse-transform and inverse quantization unit 220, thereby generating a restored image. The frame storage unit 230 stores the image restored in the addition unit 262 in a frame unit.

The offset compensating unit 240 determines an offset value, which is a difference between an average value of pixels of the current block and an average value of pixels of the reference block, as a prediction value of the current block, and generates an offset prediction value of the current block by using at least one of peripheral blocks of the current block and motion vector predictor of the current block restored after being previously encoded. Also, the offset compensating unit 240 compensates for an illumination value of the prediction block of the current block by adding a motion compensation value of the current block, that is, the reference block of the current block to the offset.

The offset encoding unit 245 encodes a difference value between an offset value of the current block and an offset prediction value.

Hereinafter, prediction of an offset value, which is a difference between an average value of pixels of the current block and an average value of pixels of the reference block, as a prediction value of the current block, in the offset compensating unit 240 will be described in detail.

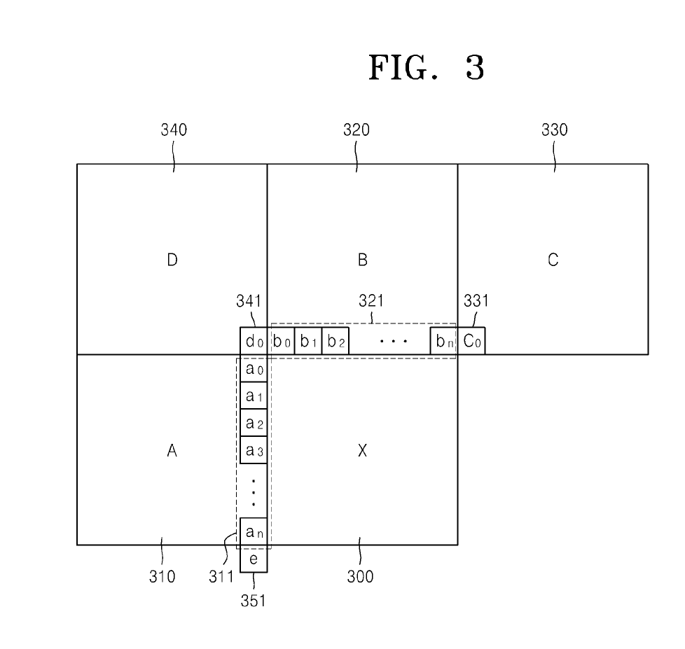

FIG. 3 is a reference diagram for explaining offset prediction according to an exemplary embodiment.

The offset compensating unit 240 calculates an offset for illumination value correction of the reference block by using the current block having an input N×M (where N and M are fixed numbers) size and the reference block, which is a prediction value of the current block output from the prediction unit 250. When the pixel value at (i,j) (where i and j are fixed numbers) of the input current block is ORG(i,j) and the pixel value at (i,j) of the reference block, which is the prediction value of the current block, is PRED(i,j), an offset may be calculated as represented by Equation 1.

$$offset = {\sum }_{i , j} \frac{ORG ( i , j ) - PRED ( i , j )}{N \times M} \qquad Equation 1$$

The offset compensating unit 240 outputs a motion compensation value of the current block, that is, a value obtained by adding the calculated offset to each pixel PRED(i,j) of the reference block, that is, a prediction block in which an illumination value having a value of PRED(i,j)+offset is compensated, to the subtraction unit 260.

In particular, the offset compensating unit 240 according to the current exemplary embodiment generates an offset prediction value of the current block by using peripheral blocks of the current block restored after being previously encoded or motion vector predictor of the current block

Referring to FIG. 3, a current block is X 300, a peripheral block to the left is A 310, a peripheral block at an upper side is B 320, and peripheral blocks at corners are C 330 and D 340, respectively. The offset compensating unit 240 may predict an offset of the current block X 300 by using an offset of at least one peripheral block from among the peripheral blocks A 310, B 320, C 330, and D 340 restored after being previously encoded. Since illumination values of the peripheral blocks adjacent to the current block X 300 may be similar to an illumination value of the current block X 300, offset values of the peripheral blocks of the current block X 300 are used to determine an offset prediction value of the current block X 300, and a difference between the offset value and the offset prediction value are encoded as offset information so that a bit rate required to transmit the offset information to a decoding side may be reduced.

More specifically, the offset compensating unit 240 may generate an offset prediction value of the current block X 300 by using the offset values of the peripheral blocks in various ways. For example, the offset compensating unit 240 may determine an offset average value of the peripheral blocks A 310, B 320, and C 330 used to determine a general motion vector predictor from among the peripheral blocks of the current block X 300 as the offset prediction value of the current block X 300.

Also, the offset compensating unit 240 may determine the offset prediction value of the current block X 300 by using the offset average value of blocks having predetermined sizes adjacent to the current block X 300 from among the peripheral blocks that are divided, instead of using offsets of the entire peripheral blocks. For example, in FIG. 3, the offset compensating unit 240 divides the peripheral blocks A 310 and B 320 adjacent to the current block X 300 into blocks having a size of 4×4, and determines an average value of offset values of blocks 311 and 321 having a size of 4×4 adjacent to the current block X 300 as the offset prediction value of the current block X 300. That is, when the peripheral block A 310 restored after being previously encoded is divided into the blocks having a size of 4×4, blocks 311 having a size of 4×4, which are closest to the left side of the current block X 300, are each referred to as a0, . . , and an. When the peripheral block B 320 restored after being previously encoded is divided into the blocks having a size of 4×4, blocks 321 having a size of 4×4, which are closest to the upper side of the current block X 300, are each referred to as b0, . . , and bn. In this regard, the offset compensating unit 240 calculates an offset average value of each block 311 and 321 a0, . . . , and an and b0, . . . , and bn and may determine the calculated average value as the offset prediction value of the current block X 300.

Also, the offset compensating unit 240 calculates an offset average value by adding not only blocks having predetermined sizes adjacent to the current block X 300 but also at least one of the blocks c0 331, d0 341, and e 351 having predetermined sizes located at the corners of the current block X 300, and may determine the calculated average value as the offset prediction value of the current block X 300. The number and types of peripheral blocks used to predict the offset of the current block may not be particularly restricted and may vary.

The offset compensating unit 240 calculates again an offset in a block unit having a predetermined size obtained by dividing the current block restored after being encoded to be used to generate an offset prediction value of a block encoded after completing encoding the current block X 300, and uses the calculated offset in predicting an offset of a next block. That is, as described above, in order to generate an offset prediction value by using the offset average value of the blocks 311 and 321 having a size of 4×4 adjacent to the current block X 300, the offset compensating unit 240 restores the block, in which encoding thereof is completed, performs motion prediction on the restored block again in a block unit having a predetermined size, calculates an offset, which is a difference in an average value between a prediction block and the restored block, and thus prepares an offset value in a block unit having a predetermined size so as to be used in encoding a next block.

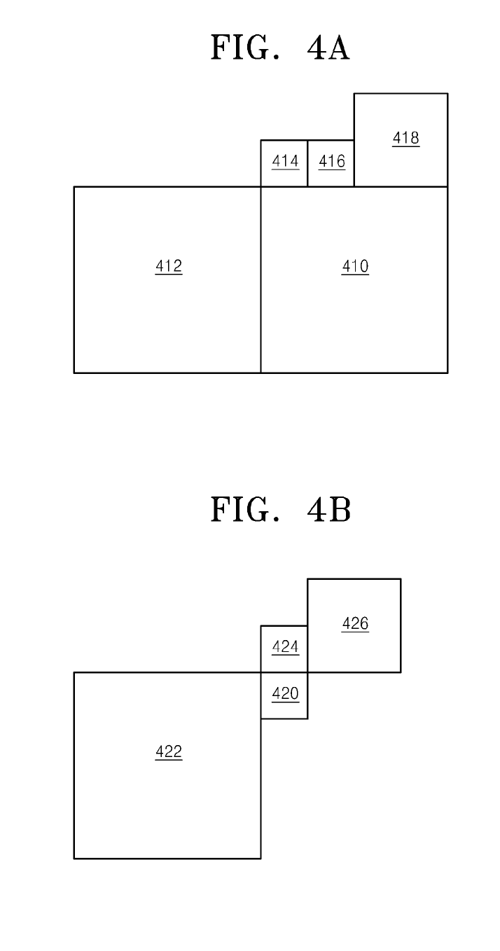

FIGS. 4A through 4B illustrate blocks having various sizes that are adjacent to a current block according to an exemplary embodiment.

In the method and apparatus for encoding video according to the exemplary embodiment, encoding units and prediction units having various sizes may be used to encode an image. Accordingly, sizes of blocks adjacent to a current block may vary, and thus a size of the current block may be greatly different from sizes of adjacent blocks.

Referring to FIG. 4A, blocks 414 through 418 adjacent to the upper side of a current block 410 are smaller than the current block 410. Peripheral blocks that are significantly smaller than the current block 410 may have different image characteristics from the current block so that the offset compensating unit 240 may generate an offset prediction value by only using offsets of the peripheral blocks having predetermined sizes or above after being compared with the size of the current block when predicting an offset. In FIG. 4A, an offset average value of blocks 418 and 412 which are larger by ¼ than the current block 410 is only used so as to be used as an offset prediction value of the current block 410.

Referring to FIG. 4B, a size of a block 422 adjacent to the left of a current block 420 is 16 times larger than the size of the current block 420, and thus it is assumed that there exists a large difference. Due to the large difference, image characteristics of the block 422 adjacent to the left of the current block 420 and the current block 420 may be different from each other. Accordingly, the offset compensating unit 240 only calculates an average value of offsets of a block 424 adjacent to the upper side of the current block 420 and a block 426 adjacent to the right upper side of the current block 420, and determines the calculated average value as an offset prediction value of the current block 420.

As such, the offset compensating unit 240 prepares a standard to determine peripheral blocks used to predict an offset of the current block according to sizes of the current block and peripheral blocks, calculates an average value of offsets of the peripheral blocks selected according to the standard, and thus determines an offset prediction value of the current block.

According to another exemplary embodiment, the offset compensating unit 240 may determine an offset value of a corresponding region indicated by a motion vector predictor of a current block as an offset prediction value of the current block.

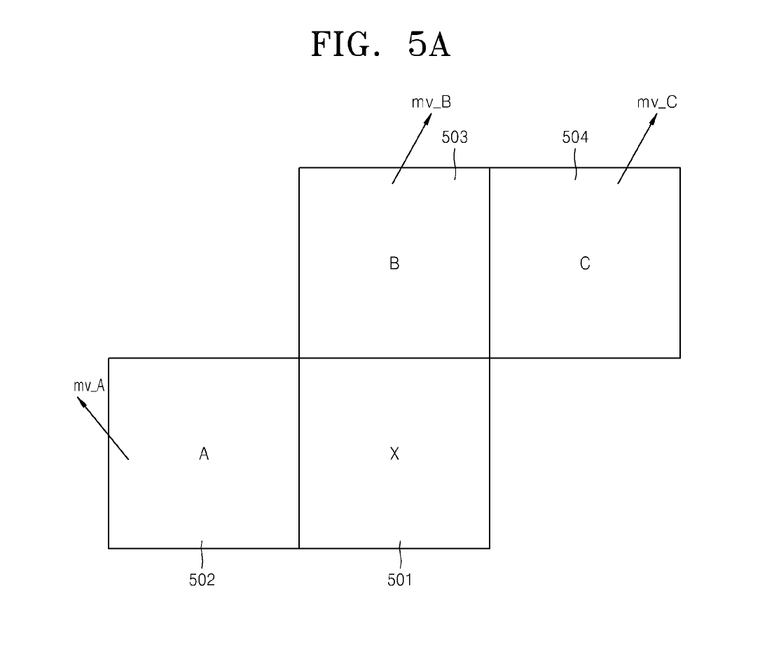

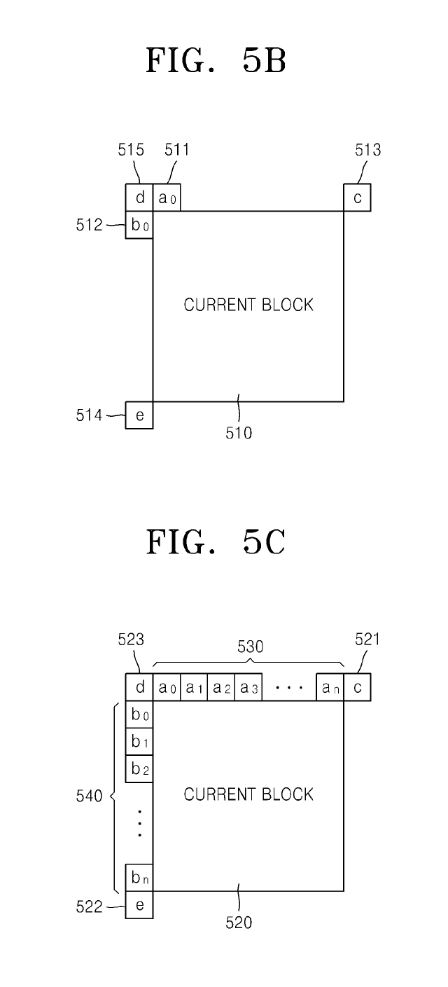

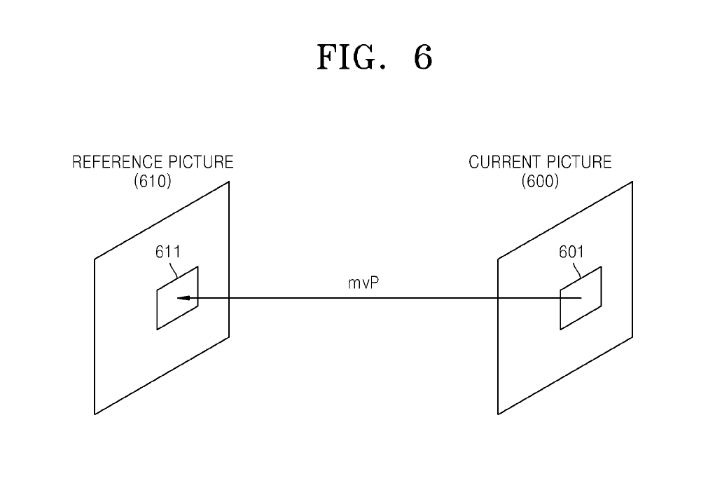

FIGS. 5A through 5C are diagrams for explaining a motion vector predictor used to determine an offset prediction value of a current block according to another exemplary embodiment.

Referring to FIG. 5A, a motion vector determined as a result of motion prediction of a current block X 501 is closely related to a motion vector mv_A of a peripheral block A 502, a motion vector mv_B of a peripheral block B 503, and a motion vector mv_C of a peripheral block C 504. Accordingly, motion vector information of the current block X 501 is not directly encoded. Instead, the motion vector of the current block is predicted from the peripheral blocks, and a difference value between the motion vector of the current block and the motion vector predictor is encoded as the motion vector information. According to another exemplary embodiment, the offset compensating unit 240 determines a corresponding region of a reference picture by using a motion vector predictor of the current block X 501, and determines an offset value of the corresponding region indicated by the motion vector predictor as an offset prediction value of the current block X 501. In FIG. 5A, the motion vector predictor of the current block X 501 may be determined to be a median of the motion vector mv_A of the peripheral block A 502, the motion vector mv_B of the peripheral block B 503, and the motion vector mv_C of the peripheral block C 504.

Referring to FIG. 5B, the offset compensating unit 240 may use one of motion vectors of previously encoded blocks adjacent to a current block 510 as a motion vector predictor of the current block 510. Any one of an a0 block 511 at the leftmost side from among blocks adjacent to the upper side of the current block 510, a b0 block 512 at the upper left side, a c block 513 adjacent to the upper right side, a d block 515 adjacent to the upper left side, and an e block 514 adjacent to the lower left side may be determined as the motion vector predictor of the current block 510. Here, a motion vector of a block which refers to a reference picture that is the same as the current block 510 when scanning the a0 block 511, the b0 block 512, the c block 513, the d block 515, and the e block 514 according to a predetermined order is determined as the motion vector predictor, or when a block which refers to a reference picture that is the same as the current block 510 does not exist, a motion vector of a motion block which refers to another reference picture may be determined as the motion vector predictor of the current block 510.

Referring to FIG. 5C, the offset compensating unit 240 may generate a motion vector predictor from peripheral blocks according to whether a peripheral block uses a reference picture that is the same as a first reference picture referred to by a current block 520, whether a peripheral block uses a reference picture located in the same list direction with the first reference picture, and whether a peripheral block is a motion block using a reference picture located in a different list direction from the first reference picture. That is, the offset compensating unit 240 may determine the motion vector predictor by using a motion vector of a peripheral block which uses the same reference picture with the first reference picture referred to by the current block, by using a motion vector of a peripheral block which uses another reference picture located at the same direction with that of the first reference picture when a peripheral block which uses the same reference picture with the first reference picture does not exist, or by using a motion vector of motion block which refers to another reference picture located at a different list direction from the first reference picture when a peripheral block which uses another reference picture located at the same direction with the first reference picture does not exist. More specifically, the offset compensating unit 240 determines a motion vector of a firstly scanned peripheral block which refers to the same reference picture with the current block as a motion vector predictor by extracting motion vector information of the peripheral blocks of the current block according to a predetermined scanning order and comparing reference picture information referred to by the current block with motion vector information referred to by the peripheral blocks. When a peripheral block, which refers to the same reference picture as the current block, does not exist, a motion vector of a firstly scanned peripheral block, which refers to a reference picture different from the current block, is determined as a motion vector predictor. Here, in blocks b0 to bn 540 adjacent to the left side of the current block 520, the predetermined scanning order may be from top to bottom, that is, from b0 to bn. In blocks a0 to an 530 adjacent to the upper side of the current block 520, the predetermined scanning order may be from left to right, that is, from a0 to an. In blocks c 521, e 522, and d 523 disposed at corners of the current block 520, the block c 521, the d block 523, and the e block 522 may be sequentially scanned in this order. Such a scanning order may not be limited to the above and may be changed. Also, a method of determining a motion vector predictor of the current block is not limited to the above and may vary.

When the motion vector predictor of the current block is determined, the offset compensating unit 240 determines an offset of a corresponding region indicated by the motion vector predictor from a reference picture as an offset prediction value of the current block.

FIG. 6 is a reference diagram for explaining determining of an offset prediction value of a current block by using a motion vector predictor according to another exemplary embodiment.

Similar to FIGS. 5A through 5C, in FIG. 6, when a motion vector predictor (MVP) of a current block 601 of a current picture 600 is determined, the offset compensating unit 240 determines an offset of a corresponding region 611 indicated by the motion vector predictor from a reference picture 610 as an offset prediction value of the current block 601. The offset of the corresponding region 611 may be calculated by a difference value between an average value of pixel values restored after being encoded in the corresponding region 611 and an average value of pixel values of a prediction block generated as a result of motion prediction for the corresponding region 611.

Referring back to FIG. 2, when the offset of the current block is determined, the offset encoding unit 245 encodes an offset difference value between an offset value of the current block and an offset prediction value as offset information. In addition, when various offset prediction methods are set according to each different offset prediction mode, encoded offset information of the current block may include indexing information indicating each offset prediction mode.

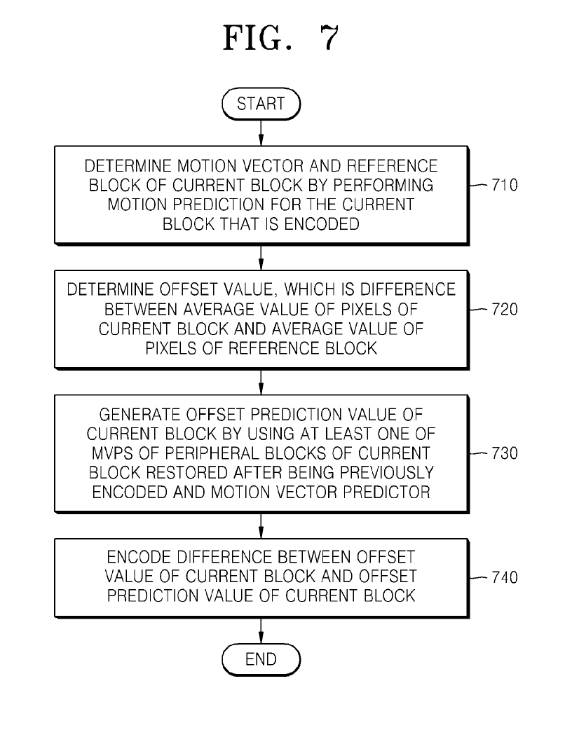

FIG. 7 is a flowchart illustrating a method of encoding video according to an exemplary embodiment.

Referring to FIG. 7, in operation 710, the prediction unit 250 determines a motion vector and a reference block of a current block by performing motion prediction on the current block that is encoded. As described above, in single view video encoding, the reference block may be a block in a previous restored frame or a block in a frame of a different color component that is previously restored in the current frame. In multi-view video encoding, the reference block may be a block in a frame at any one view restored after being firstly encoded from among video sequences at a plurality of views.

In operation 720, the offset compensating unit 240 determines an offset value, which is a difference between an average value of pixels of the current block and an average value of pixels of the reference block. The offset value may be calculated as represented by Equation 1 above.

In operation 730, the offset compensating unit 240 generates an offset prediction value of the current block by using at least one of motion vector predictor (MVP) of the current block and peripheral blocks restored after being previously encoded. As described above, the offset compensating unit 240 may determine an average value of offsets of peripheral blocks of the current block as an offset prediction value of the current block or may determine an offset average value of blocks having predetermined sizes adjacent to the current block as an offset prediction value of the current block. Also, the offset compensating unit 240 may determine an offset of a corresponding region of a reference picture indicated by the motion vector predictor of the current block as an offset prediction value of the current block.

In operation 740, the offset encoding unit 245 encodes a difference between an offset value of the current block and the offset prediction value of the current block.

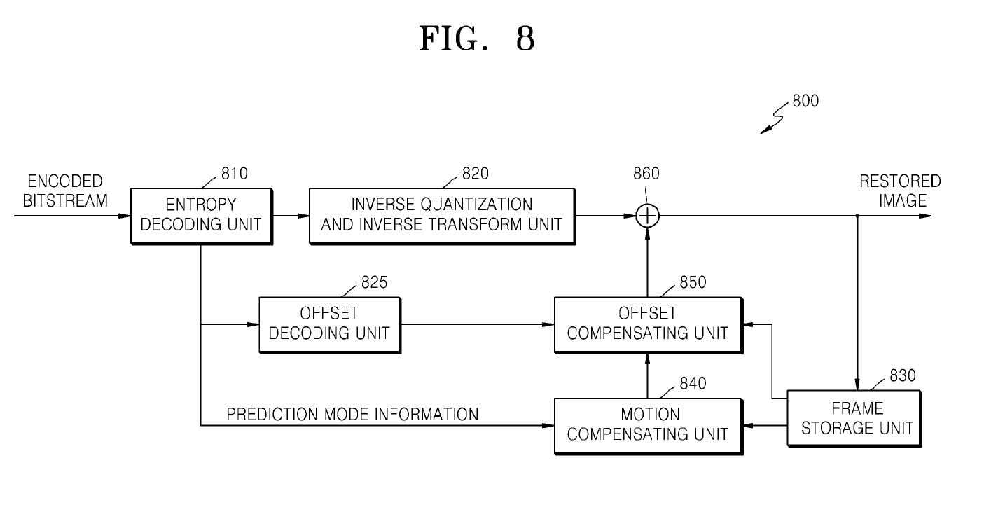

FIG. 8 is a block diagram of an apparatus for decoding video according to an exemplary embodiment.

Referring to FIG. 8, the apparatus 800 for decoding video includes an entropy decoding unit 810, an inverse quantization and inverse transform unit 820, an offset decoding unit 825, a frame storage unit 830, a motion compensating unit 840, an offset compensating unit 850, and an addition unit 860.

The entropy decoding unit 810 entropy decodes an encoded bit stream so as to extract image data, prediction mode information, and offset information. The entropy decoded image data is input to the inverse quantization and inverse transform unit 820, the prediction mode information is input to the motion compensating unit 840, and the offset information is input to the offset decoding unit 825.

The offset decoding unit 825 restores a decoded current block by using the offset information extracted from the bit stream. More specifically, the offset decoding unit 825 generates an offset prediction value of a current block by using at least one of motion vector predictor of the current block and peripheral blocks of a previously restored current block. Also, the offset decoding unit 825 restores an offset by adding an offset difference value of the current block extracted from the bit stream to the offset prediction value. Generating of the offset prediction value is the same as the generating of the offset prediction value in the offset compensating unit 240 of FIG. 2, and thus a detailed description thereof will be omitted here.

The inverse-transform and inverse quantization unit 820 performs inverse transform and inverse quantization for the image data extracted from the entropy decoding unit 810. The addition unit 860 restores an image by adding the image data that is inverse quantized and inverse transformed in the inverse-transform and inverse quantization unit 820 to a prediction block, in which a brightness value is compensated in the offset compensating unit 850, and the frame storage unit 830 stores the restored image in a frame unit.

The motion compensating unit 840 outputs a motion compensated reference block, which is a prediction value of the current block by using a motion vector of the current block decoded by using the prediction mode information extracted from the bit stream.

The offset compensating unit 850 compensates for a brightness value of the reference block of the current block by adding a motion compensation value of the current block to the offset value of the current block. Also, the offset compensating unit 850 calculates again an offset in a block unit having a predetermined size obtained by dividing the restored current block in order to be used in the generating of the offset prediction value of the block decoded after the decoding of the current block is completed so that the calculated offset is used to predict an offset of a next block.

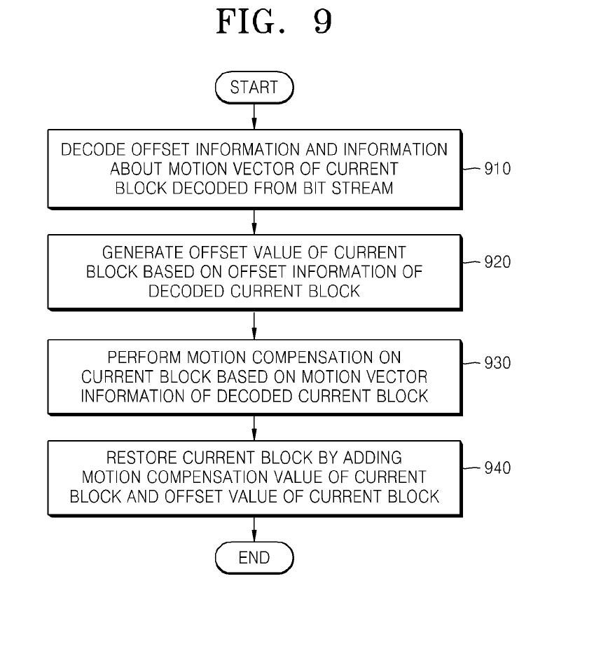

FIG. 9 is a flowchart illustrating a method of decoding video according to an exemplary embodiment.

Referring to FIG. 9, in operation 910, the entropy decoding unit 810 decodes offset information and information about a motion vector of a current block decoded from the bit stream.

In operation 920, the offset decoding unit 825 generates an offset value of the current block based on the offset information of the decoded current block. As described above, the offset decoding unit 825 generates an offset prediction value of the current block by using at least one of motion vector predictor of current block and the peripheral blocks of the current block previously restored current block and the current block. Also, the offset decoding unit 825 restores an offset by adding a difference value between the offset of the current block extracted from the bit stream and an offset to the offset prediction value.

In operation 930, the motion compensating unit 840 performs motion compensation on the current block based on the motion vector information of the decoded current block and outputs the reference block, which is a prediction value of the motion compensated current block, to the offset compensating unit 850.

In operation 940, the offset compensating unit 850 outputs a prediction block, in which a brightness value is compensated, by adding the motion compensation value of the current block to the offset value of the current block. The addition unit 860 restores the current block by adding the prediction block, in which a brightness value is compensated, to a residual value output from the inverse quantization and inverse transform unit 820.

The exemplary embodiments may be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

The exemplary embodiments may be embodied by an apparatus that includes a bus coupled to every unit of the apparatus, at least one processor (e.g., central processing unit, microprocessor, etc.) that is connected to the bus for controlling the operations of the apparatus to implement the above-described functions and executing commands, and a memory connected to the bus to store the commands, received messages, and generated messages.

As will also be understood by the skilled artisan, the exemplary embodiments, including units and/or modules thereof, may be implemented by any combination of software and/or hardware components, such as a Field Programmable Gate Array (FPGA) or Application Specific Integrated Circuit (ASIC), which performs certain tasks. A unit or module may advantageously be configured to reside on the addressable storage medium and configured to execute on one or more processors or microprocessors. Thus, a unit or module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or modules or further separated into additional components and units or modules.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of encoding video, the method comprising:
determining a motion vector and a reference block of an encoded current block by performing motion prediction on the current block;
determining an offset value of the current block that is a difference between an average value of pixels of the current block and an average value of pixels of the reference block;
generating an offset prediction value of the current block by using at least one of a motion vector predictor of the current block and peripheral blocks of the current block restored after being encoded; and
encoding a difference value that is a difference between the offset value of the current block and the offset prediction value of the current block.

2. The method of claim 1, wherein the video is three-dimensional (3D) video, the reference block is a block of at least one video from among left video and right video that are restored after being previously encoded, and the current block is a block of video that is different from the reference block.

3. The method of claim 1, wherein the video is multi-view video, the reference block is a block of video at a first view that is restored after being previously encoded, and the current block is a block of video at a second view different from the first view.

4. The method of claim 1, wherein the generating of the offset prediction value of the current block comprises determining the offset prediction value of the current block by using an offset average value of blocks having predetermined sizes that are adjacent to the current block.

5. The method of claim 4, wherein the blocks having predetermined sizes are blocks having a size of 4×4 and an offset of the blocks having a size of 4×4 is previously calculated.

6. The method of claim 1, wherein the generating of the offset prediction value of the current block comprises determining an offset of a corresponding region of a reference picture indicated by the motion vector predictor of the current block as the offset prediction value of the current block.

7. The method of claim 1, wherein the generating of the offset prediction value of the current block comprises generating the offset prediction value by using an offset average value of peripheral blocks adjacent to the left side of the current block, peripheral blocks adjacent to the upper side of the current block, and peripheral blocks located at corners of the current block.

8. The method of claim 1, wherein when a peripheral block which refers to a same reference picture as the current block exists, the motion vector predictor of the current block is determined as a motion vector of the peripheral block which refers to the same reference picture, and when the peripheral block which refers to the same reference picture as the current block does not exist, the motion vector predictor of the current block is determined as a motion vector of a peripheral block which refers to a reference picture that is different from the reference picture of the current block.

9. The method of claim 1, further comprising performing motion compensation by adding the offset value of the current block to each pixel value of the reference block.

10. The method of claim 1, further comprising:
performing decoding and restoration on the current block; and
performing motion prediction on the restored current block in a block unit having a predetermined size and calculating an offset value in a block unit having the predetermined size.

11. The method of claim 1, further comprising adding information about the offset prediction value of the current block to a bit stream.

12. A method of decoding video, the method comprising:
decoding offset information and information about a motion vector of a current block decoded from a bit stream;
generating an offset value of the current block based on the decoded offset information of the decoded current block;
performing motion compensation on the current block based on the motion vector information of the decoded current block; and
restoring the current block by adding a motion compensation value of the current block to the offset value of the current block,
wherein the offset information comprises a difference value that is a difference between an offset prediction value of the current block and the offset value of the current block, the offset prediction value of the current block generated by using at least one of a motion vector predictor of the current block and previously restored peripheral blocks of the current block.

13. The method of claim 12, wherein the video is three-dimensional (3D) video, the reference block is a block of one video from among left video and right video that are restored after being previously encoded, and the current block is a block of video that is different from the reference block.

14. The method of claim 12, wherein the video is multi-view video, the reference block is a block of video at a first view that is restored after being previously encoded, and the current block is a block of video at a second view different from the first view.

15. The method of claim 12, wherein the offset prediction value of the current block is generated by using an offset average value of blocks having predetermined sizes that are adjacent to the current block and the offset value is generated by adding the difference value to the offset prediction value.

16. The method of claim 15, wherein the blocks having predetermined sizes are blocks having a size of 4×4 and an offset of the blocks having a size of 4×4 is previously calculated.

17. The method of claim 12, wherein the offset prediction value of the current block is determined as an offset of a corresponding region of a reference picture indicated by motion vector predictor of the current block and the offset value is generated by adding the difference value to the offset prediction value.

18. The method of claim 12, wherein the offset prediction value of the current block is generated by using an offset average value of peripheral blocks adjacent to the left side of the current block, peripheral blocks adjacent to the upper side of the current block, and peripheral blocks located at corners of the current block.

19. The method of claim 12, wherein when a peripheral block which refers to a same reference picture as the current block exists, a motion vector predictor of the current block is determined as a motion vector of the peripheral block which refers to the same reference picture, and when the peripheral block which refers to the same reference picture as the current block does not exist, the motion vector predictor of the current block is determined as a motion vector of a peripheral block which refers to a reference picture that is different from the reference picture of the current block.

20. The method of claim 12, further comprising performing motion prediction on the restored current block in a block unit having a predetermined size and calculating an offset value in a block unit having the predetermined size.

21. An apparatus for encoding video, the apparatus comprising:
a prediction unit that determines a motion vector and a reference block of an encoded current block by performing motion vector predictor on the current block;
an offset compensating unit that determines an offset value of the current block that is a difference between an average value of pixels of the current block and an average value of pixels of the reference block, generates an offset prediction value of the current block by using at least one of a motion vector predictor of the current block and peripheral blocks of the current block restored after being encoded, and compensating for a brightness value of a reference block of the current block by adding a motion compensation value of the current block and the offset; and
an offset encoding unit that encodes a difference value that is a difference between the offset value of the current block and the offset prediction value of the current block.

22. An apparatus for decoding video, the apparatus comprising:
an offset decoding unit that decodes offset information of a current block decoded from a bit stream and generates an offset value of the current block based on the decoded offset information;
a motion compensating unit that performs motion compensation on the current block based on motion vector information of the decoded current block; and
an offset compensating unit that compensates for a brightness value of a reference block of the current block by adding a motion compensation value of the current block to the offset value of the current block,
wherein the offset information comprises a difference value that is a difference between an offset prediction value of the current block and the offset value of the current block, the offset prediction value of the current block generated by using at least one of a motion vector predictor of the current block and previously restored peripheral blocks of the current block.
